(19) United States
(12) Patent Application Publication
(10) Pub. No.: US 2023/0311479 A1
(43) Pub. Date: Oct. 5, 2023

(54) INK-JET RECORDING APPARATUS

(71) Applicant: KYOCERA Document Solutions Inc., Osaka (JP)

(72) Inventor: Aiichiro OTANA, Osaka (JP)

(73) Assignee: KYOCERA Document Solutions Inc., Osaka (JP)

(21) Appl. No.: 18/188,935

(22) Filed: Mar. 23, 2023

(30) Foreign Application Priority Data
Apr. 1, 2022 (JP) 2022-061629

(51) Int. Cl. B41J 2/03; B41J 23/20; B41J 11/00; B41J 2/17; B41J 2/045

(52) U.S. Cl. CPC B41J 2/03; B41J 23/20; B41J 11/007; B41J 2/1707; B41J 2/04595

(57) ABSTRACT

An ink-jet recording apparatus includes a recording head including a plurality of pressurizing chambers for storing ink and a plurality of pressurizing elements for pressing ink in the pressurizing chambers to eject ink from nozzles; a head driver including a driving pulse generator that applies a drive voltage to the pressurizing element to generate a drive waveform for ejecting ink from the nozzles; a conveying belt having a plurality of openings which conveys a recording medium; and a control portion. The control portion controls the driving of the head driver and the conveying belt to perform flushing where ink droplets are ejected from the nozzles in the recording head to pass through one of the plurality of openings with a timing different from that for image recording, using a drive waveform with which the ink droplets ejected from the nozzle each become one droplet before passing through the openings.

### INCORPORATION BY REFERENCE

This application is based upon and claims the benefit of priority from the corresponding Japanese Patent Application No. 2022-061629 filed on Apr. 1, 2022, the entire contents of which are hereby incorporated by reference.

### BACKGROUND

The present disclosure relates to an ink-jet recording apparatus.

Conventionally, to reduce or prevent nozzle clogging due to ink dehydration on ink-jet recording apparatuses such as ink-jet printers, flushing (blank ejection) is performed in which ink is periodically ejected from nozzles. For example, openings for flushing are provided at predetermined intervals in a conveying belt for conveying a recording medium, and ink is ejected from the nozzles in a recording head with a predetermined timing while the conveying belt makes one turn so as to pass through the openings in the conveying belt.

The openings in the conveying belt are formed larger than apertures for sucking on sheets so that the ink ejected during flushing can easily pass through the openings. Thus, in the parts of the conveying belt where the openings are formed, the belt is mechanically less strong and stretches differently than elsewhere. As a result, every time a part of the conveying belt where an opening group is formed makes contact with a driving roller, the belt speed slightly drops. A change in the belt speed during ink ejection to a recording medium for image recording leads to degraded image quality. Inconveniently, however, reducing the size of the openings to keep the belt strong enough causes ink to land elsewhere than in the openings to contaminate the obverse face of the conveying belt.

### SUMMARY

According to one aspect of the present disclosure, an inkjet recording apparatus includes a recording head, a head driver, a conveying belt, and a control portion. The recording head includes a plurality of pressurizing chambers which communicate with a plurality of nozzles for ejecting ink and in which ink can be stored. The recording head also includes a plurality of pressurizing elements which are arranged so as to correspond to the plurality of pressurizing chambers. The pressurizing elements apply pressures to the ink in the pressurizing chambers to eject ink from the nozzles. The head driver includes a driving pulse generator that applies a drive voltage to the pressurizing elements to generate a drive waveform for ejecting ink from the nozzles, and makes each of the nozzles eject ink for one pieces of pixel data in the image data to be printed in accordance with gradation of the pixel data. The conveying belt is endless, has a plurality of openings, and conveys, while holding, a recording medium. The control portion controls the driving of the head driver and the conveying belt to perform flushing in which ink droplets are ejected from the nozzles in the recording head to pass through one of the plurality of openings with timing different from the timing with which to record an image. The control portion performs the flushing using the drive waveform with which the ink droplets ejected from the nozzle each become one droplet before passing through the openings.

### BRIEF DESCRIPTION OF THE DRAWINGS

FIG. 1 is a diagram illustrating an outline of the construction of a printer as an ink-jet recording apparatus according to one embodiment.

FIG. 2 is a plan view of a recording portion included in the printer.

FIG. 3 is a diagram schematically showing the construction of and around a conveying path of a sheet from a sheet feeding cassette via a first conveying unit to a second conveying unit in the printer.

FIG. 4 is a block diagram showing a hardware configuration of a principal portion of the printer.

FIG. 5 is an enlarged sectional view showing the structure of a principal portion of a recording head.

FIG. 6 is a plan view showing one example of the structure of a first conveying belt used in the printer.

FIG. 7 is a partly enlarged view of and around openings in the first conveying belt in FIG. 6.

FIG. 8 is a schematic diagram showing air flows around the first conveying belt when the first conveying belt passes under the recording head.

FIG. 9 is a schematic diagram showing how two ink droplets, while flying, unite (merge) into one ink droplet and pass through an opening.

### DETAILED DESCRIPTION

### 1. Configuration of an Ink-Jet Recording Apparatus

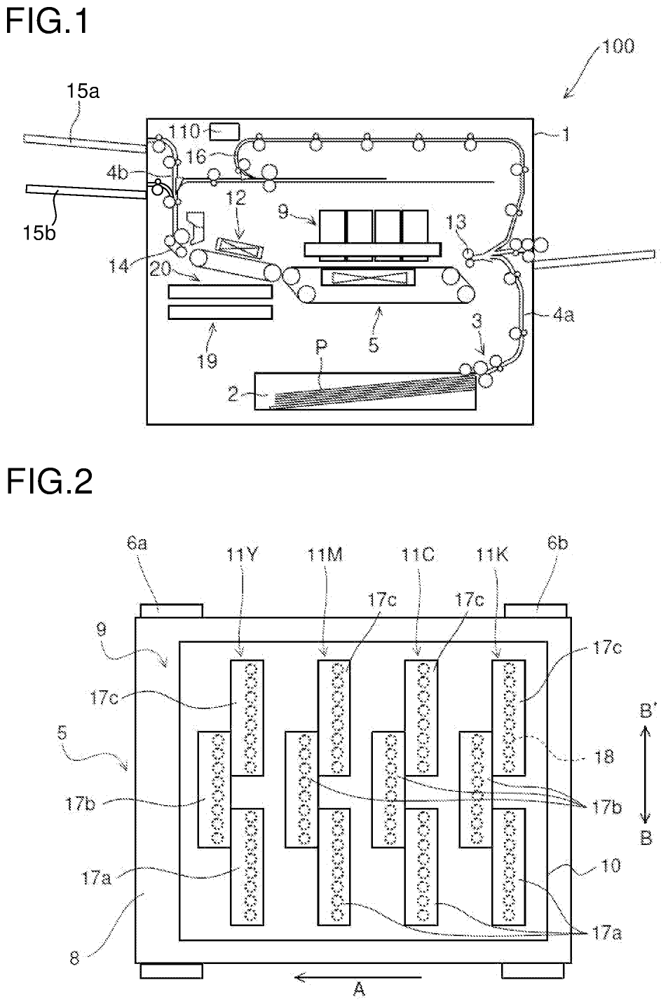

Hereinafter, with reference to the accompanying drawings, embodiments of the present disclosure will be described. FIG. 1 is a diagram illustrating an outline of the construction of a printer 100 as an ink-jet recording apparatus according to one embodiment of the present disclosure. The printer 100 includes a sheet feeding cassette 2 which is a sheet storage portion. The sheet feeding cassette 2 is arranged in a lower part inside a printer main body 1. Inside the sheet feeding cassette 2, sheets P as one example of a recording medium are stored.

On the downstream side of the sheet feeding cassette 2 in the sheet conveying direction, that is, to the upper right of the sheet feeding cassette 2 in FIG. 1, a sheet feeding device 3 is arranged. By the sheet feeding device 3, sheets P are fed out one after another separately to the upper right of the sheet feeding cassette 2 in FIG. 1.

The printer 100 is provided with a first sheet conveying passage 4a inside. The first sheet conveying passage 4a is located to the upper right with respect to the sheet feeding cassette 2, that is, in the sheet feeding direction. Sheets P fed out of the sheet feeding cassette 2 are conveyed vertically upward along a side face of the printer main body 1 via the first sheet conveying passage 4a.

At the downstream end of the first sheet conveying passage 4a in the sheet conveying direction, a pair of registration rollers 13 is provided. Close to a downstream-side part of the pair of registration rollers 13 in the sheet conveying direction, a first conveying unit 5 and a recording portion 9 are arranged. A sheet P fed out of the sheet feeding cassette 2 reaches the pair of registration rollers 13 via the first sheet conveying passage 4a. The pair of registration rollers 13, while correcting skewed conveying of sheets P and coordinating with the timing of ink ejecting operation by the recording portion 9, feeds out the sheets P toward the first conveying unit 5 (in particular, toward a first conveying belt 8 described later).

The sheet P sent out to the first conveying unit 5 by the pair of registration rollers 13 is conveyed to a position where the first conveying belt 8 and the recording portion 9 (in particular, the recording heads 17a to 17c described later) face each other. As ink is ejected from the recording portion 9 to the sheet P, an image is recorded on the sheet P. Here, the ejection of ink in the recording portion 9 is controlled by a control device 110 inside the printer 100.

On the downstream side (left side in FIG. 1) of the first conveying unit 5 in the sheet conveying direction, a second conveying unit 12 is arranged. A sheet P having an image recorded on it by the recording portion 9 is conveyed to the second conveying unit 12. The ink ejected onto the surface of the sheet P is dried while the sheet P passes through the second conveying unit 12.

On the downstream side of the second conveying unit 12 in the sheet conveying direction, near the left side face of the printer main body 1, a decurler portion 14 is provided. The sheet P with the ink dried by the second conveying unit 12 is conveyed to the decurler portion 14 so that the curled sheet P is straightened.

On the downstream side (in an upper part in FIG. 1) of the decurler portion 14 in the sheet conveying direction, a second sheet conveying passage 4b is provided. The sheet P that has passed through the decurler portion 14 is, when no double-sided recording is performed, discharged through the second sheet conveying passage 4b to a sheet discharge tray 15a provided outside the left side face of the printer 100. Under the sheet discharge tray 15a, a sub discharge tray 15b for discharging unnecessary sheets P (waste sheets) due to printing failure or the like is provided.

In an upper part of the printer main body 1, over the recording portion 9 and the second conveying unit 12, a reversing conveying passage 16 for double-sided recording is provided. When double-sided recording is performed, the sheet P having the recording on its one side (first side) completed and having passed through the second conveying unit 12 and the decurler portion 14 is conveyed via the second sheet conveying passage 4b to the reversing conveying passage 16.

The sheet P conveyed to the reversing conveying passage 16 has its conveying direction switched for recording on the other side (a second side). Then, the sheet P is conveyed rightward through the upper part of the printer main body 1, and is then conveyed via the pair of registration rollers 13 to the first conveying unit 5 again with the second side up. At the first conveying unit 5, the sheet P is conveyed opposite the recording portion 9, and, as ink is ejected from the recording portion 9, an image is recorded on the second side. The sheet P having images recorded on both its faces passes through the second conveying unit 12, the decurler portion 14, and the second sheet conveying passage 4b in this order and is then discharged onto the sheet discharge tray 15a.

Under the second conveying unit 12, a maintenance unit 19 and a cap unit 20 are arranged. The maintenance unit 19, when it performs purging, horizontally moves to under the recording portion 9 where it wipes off the ink pushed out of nozzles 18 (see FIG. 2) in the recording heads 17a to 17c and collects the wiped-off ink. Here, purging means operation to forcibly push out ink from the nozzles 18 in the recording heads 17a to 17c to discharge thickened ink, foreign matter and air bubbles inside the nozzles 18. A cap unit 20, when it caps the ink ejection face of the recording heads 17a to 17c, horizontally moves to under the recording portion 9, and then moves upward to be attached to the bottom face of the recording heads 17a to 17c.

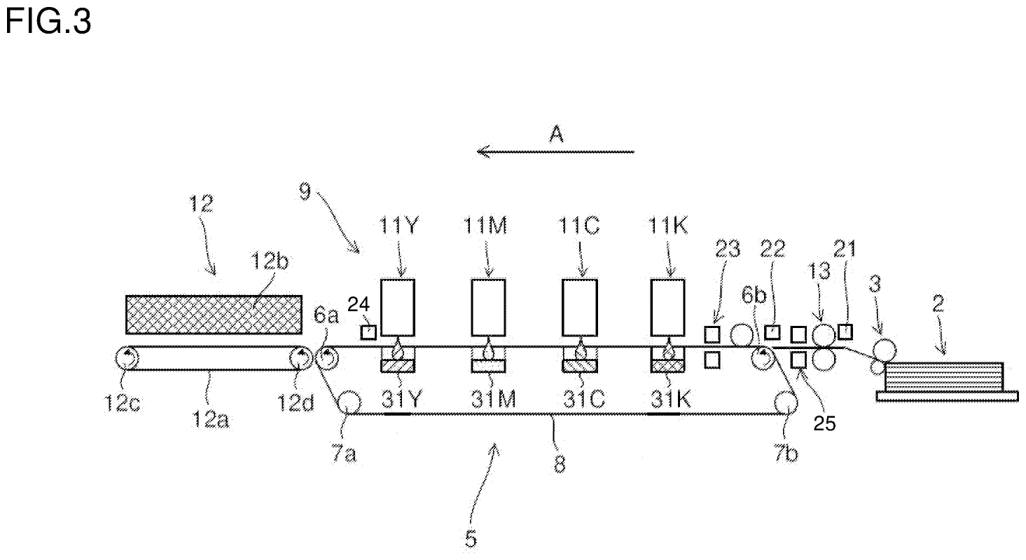

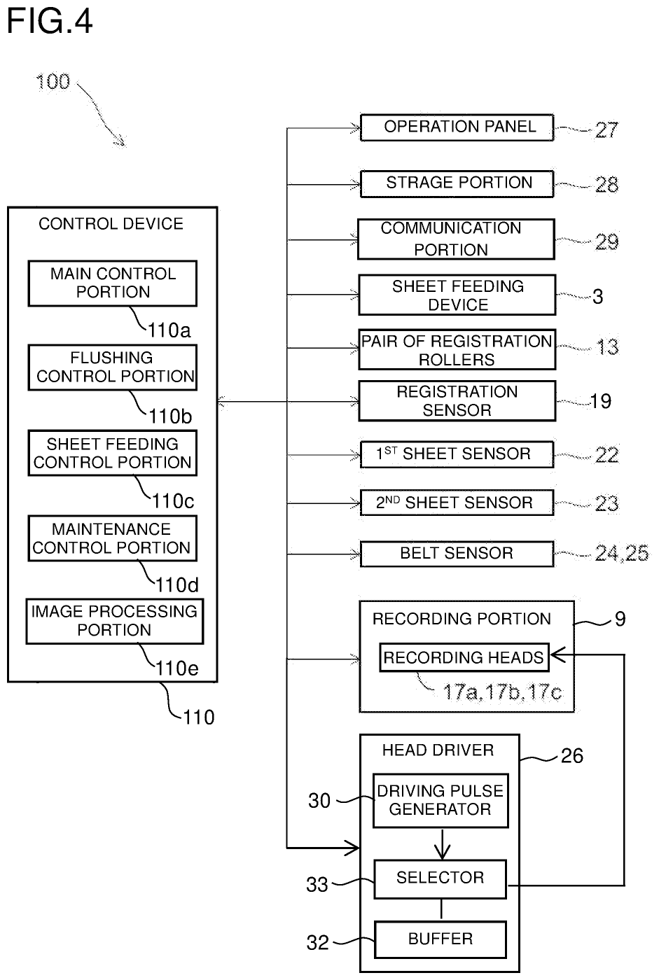

FIG. 2 is a plan view of the recording portion 9. The recording portion 9 includes a head housing 10 and line heads 11Y, 11M, 11C and 11K. The line heads 11Y to 11K are held on the head housing 10 at such a height as to keep a predetermined distance (for example, 1 mm) from the conveying face of the endless first conveying belt 8 that is stretched around a plurality of rollers including a driving roller 6a, a driven roller 6b, and tension rollers 7a and 7b (see FIG. 3). The driving roller 6a runs the first conveying belt 8 in the conveying direction (arrow A direction) of the sheet P. The driving of the driving roller 6a is controlled by a main control portion 110a (see FIG. 4) in the control device 110. As the plurality of rollers mentioned above, the tension roller 7a, the tension roller 7b, the driven roller 6b, and the driving roller 6a are arranged in this order in the traveling direction of the first conveying belt 8 (see FIG. 3).

The line heads 11Y to 11K each include a plurality of (here, three) recording heads 17a to 17c. The recording heads 17a to 17c are arranged in a staggered formation along the sheet width direction (arrow BB′ direction) perpendicular to the sheet conveying direction (arrow A direction). The recording heads 17a to 17c have a plurality of nozzles 18. The nozzles 18 are arranged in a row at equal intervals in the width direction of the recording head, that is, in the sheet width direction (arrow BB′ direction). From the line heads 11Y to 11K, via the nozzles 18 in the recording heads 17a to 17c, yellow (Y), magenta (M), cyan (C), and black (K) ink is each ejected toward the sheet P conveyed by the first conveying belt 8.

FIG. 3 schematically shows the construction of and around the conveying path of the sheet P from the sheet feeding cassette 2 via the first conveying unit 5 to the second conveying unit 12. FIG. 4 is a block diagram showing the hardware configuration of a principal portion of the printer 100. The printer 100 further includes, in addition to what has been mentioned above, a registration sensor 21, a first sheet sensor 22, a second sheet sensor 23, and belt sensors 24 and 25.

The registration sensor 21 detects the sheet P that is conveyed by the sheet feeding device 3 from the sheet feeding cassette 2 to the pair of registration rollers 13. The registration sensor 21 is positioned upstream of the pair of registration rollers 13 in the sheet P feeding direction. The control device 110 (for example, the sheet feeding control portion 110c) controls the rotation start timing of the pair of registration rollers 13 based on the result of detection by the registration sensor 21. For example, the control device 110, based on the result of detection by the registration sensor 21, controls the timing of the feeding of the sheet P to the first conveying belt 8 after skew correction by the pair of registration rollers 13.

The first sheet sensor 22 senses the position, in the width direction, of the sheet P to be conveyed from the pair of registration rollers 13 to the first conveying belt 8. The control device 110 (for example, the main control portion 110a) can record an image on the sheet P by ejecting ink from, of the nozzles 18 in the recording heads 17a to 17c in each of the line heads 11Y to 11K, the nozzles 18 corresponding to the width of the sheet P based on the result of detection by the first sheet sensor 22.

The second sheet sensor 23 senses the passage of the sheet P fed by the pair of registration rollers 13 to the first conveying belt 8. That is, the second sheet sensor 23 senses the position of the sheet P, in its conveying direction, conveyed by the first conveying belt 8. The second sheet sensor 23 is located upstream of the recording portion 9, but downstream of the first sheet sensor 22, in the sheet conveying direction. The control device 110 (for example, the main control portion 110a) can, based on the result of detection by the second sheet sensor 23, control the timing of ejecting ink to the sheet P that is conveyed by the first conveying belt 8 to a position opposite the line heads 11Y to 11K (recording heads 17a to 17c).

The belt sensors 24 and 25 are reference detection sensors for detecting a reference specifying portion Mref (see FIG. 6) provided in the first conveying belt 8. The reference specifying portion Mref is a reference for one turn of the first conveying belt 8 and is composed of a combination of two adjacent opening groups 82 as will be described later. As will be described later, the positional relationships between the reference specifying portion Mref and other opening groups 82 are prescribed; thus, when the belt sensors 24 and 25 detect the reference specifying portion Mref in the first conveying belt 8, it is then possible, based on the detected position of the reference specifying portion Mref, to detect the positions, in the conveying direction, of the opening groups 82 provided in the first conveying belt 8. Thus, the belt sensors 24 and 25 can be understood to function as opening position detection portions for detecting the positions of the opening groups 82 (openings 80) in the first conveying belt 8.

It is also possible to detect the positions of the opening groups 82 by putting marks at positions corresponding to the opening groups 82 in end parts of the first conveying belt 8 in the belt width direction and making the belt sensors 24 and 25 detect the marks.

The belt sensor 24 is positioned downstream of the recording portion 9 in the sheet conveying direction (the traveling direction of the first conveying belt 8). The belt sensor 25 is positioned upstream, in the sheet conveying direction, of the driven roller 6b around which the first conveying belt 8 is stretched. In the embodiment, the belt sensor 25 is positioned between the driven roller 6b and the tension roller 7b, but it can be positioned between the tension rollers 7a and 7b. The driven roller 6b is positioned upstream of the recording portion 9 in the traveling direction of the first conveying belt 8. The belt sensor 24 has a function equivalent to that of the second sheet sensor 23. The control device 110 (for example, the sheet feeding control portion 110c) can, based on the result of detection by the belt sensor 24 or 25, control the pair of registration rollers 13 so as to feed the sheet P to the first conveying belt 8 with predetermined timing.

The position of the sheet P may be detected with a plurality of sensors (the second sheet sensor 23 and the belt sensor 24) and the reference specifying portion Mref in the first conveying belt 8 may be detected with a plurality of sensors (the belt sensors 24 and 25). It is then possible to correct errors in the detected positions and to detect failures.

The first and second sheet sensors 22 and 23 and the belt sensors 24 and 25 described above may each be configured as an optical sensor of a transmissive or reflective type, a CIS sensor (contact image sensor), or the like.

A configuration is also possible where the printer 100 includes a meandering detection sensor for detecting the meandering of the first conveying belt 8 and corrects the meandering of the first conveying belt 8 based on the detection result.

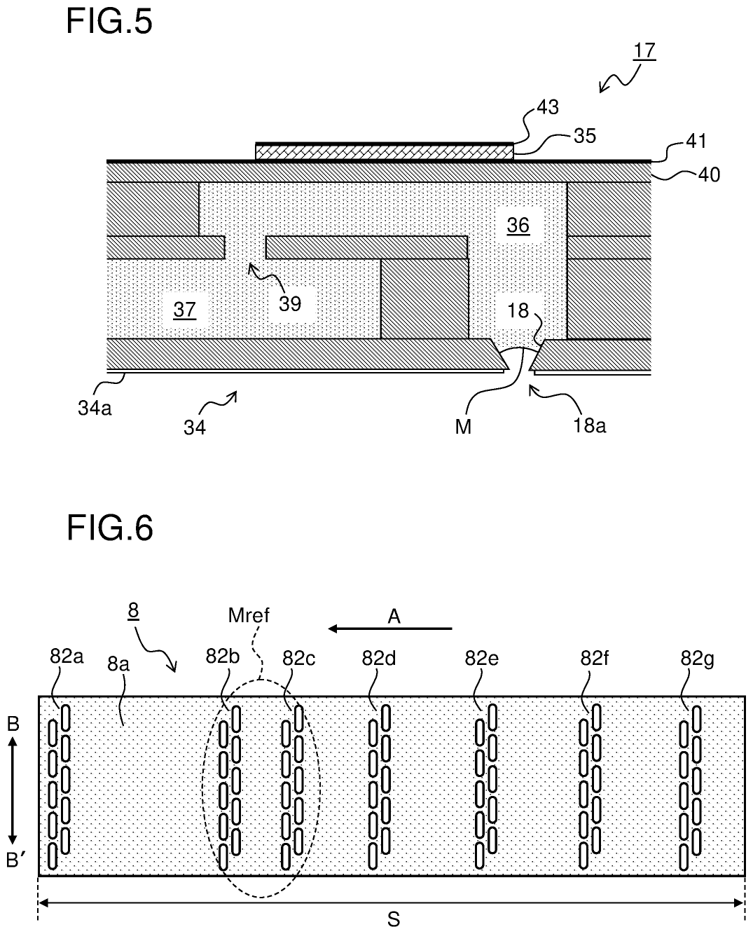

A head driver 26 includes a driving pulse generator 30, a buffer 32, and a selector 33. The driving pulse generator 30 generates a drive voltage for driving a pressurizing element 35 (see FIG. 5) in the recording heads 17a to 17c. When the drive voltage is applied to the pressurizing element 35, an amplified oscillating waveform of the proper oscillation period of the pressurizing chamber 36 occurs. That is, a waveform of the drive voltage that displaces the pressurizing element 35 is a drive waveform, and a drive waveform that ejects ink is ink ejection pulses.

The buffer 32 stores drive waveform selection data for one page of an image generated by an image processing portion 110e. The selector 33, based on the drive waveform selection data for one page stored in the buffer 32, applies a drive voltage having a drive waveform for image recording to the pressurizing elements 35 in the recording heads 17a to 17c, or, instead of selecting a drive waveform, keeps the drive voltage of the pressurize elements 35 in the recording heads 17a to 17c constant. The selector 33 also applies a drive voltage having a drive waveform used during flushing to the pressurizing element 35 in the recording heads 17a to 17c to perform flushing as will be described later.

FIG. 5 is an enlarged sectional view showing the structure of a principal portion of and around the recording heads 17a to 17c. As shown in FIG. 5, the recording heads 17a to 17c each have an ejection face 34 that faces a sheet. In the ejection face 34, a plurality of minute-diameter ejection apertures 18a, which are openings in the nozzles 18, are provided at least over the maximum width of the printing region in the longitudinal direction (main scanning direction) of the ejection face 34.

The recording heads 17a to 17c each include a water-repellent film 34a that covers the ejection face 34 except over the ejection apertures 18a, pressurizing chambers 36 provided one for each of the ejection apertures 18a, an ink tank (not shown) for storing ink, and a common flow passage 37 for feeding ink from the ink tank to a plurality of pressurizing chambers 36. The pressurizing chamber 36 and the common flow passage 37 communicate with each other through a feeding hole 39 and, via the feeding hole 39, ink is supplied from the common flow passage 37 to the pressurizing chamber 36. The nozzle 18 is continuous from inside the pressurizing chamber 36 to the ejection aperture 18a.

Of the walls of the pressurizing chamber 36, the one facing away from the ejection face 34 is configured with a vibration plate 40. The vibration plate 40 is formed continuously across a plurality of pressurizing chambers 36. A common electrode 41 likewise formed continuously across the plurality of pressurizing chambers 36 is laid on the vibration plate 40. On the common electrode 41, a separate pressurizing element 35 is provided for each of the pressurizing chambers 36. For each of the pressurizing chamber 36, an individual electrode 43 is provided so as to hold, between it and the common electrode 41, the pressurizing element 35. For the pressurizing element 35, a piezoelectric element, an electrostatic element (electrostatic actuator), or a heating element (used in a thermal ink-jet system) can be used. Using as the pressurizing element 35 a displacement element such as a piezoelectric element or electrostatic element that is displaced in accordance with a drive waveform to change the volume of the pressurizing chamber 36 permits direct conversion of the drive waveform into a pressure; this makes it easy to generate a pressure at a desired timing as will be described later.

As a result of the drive voltage generated by the driving pulse generator 30 in the head driver 26 being applied to the individual electrodes 43, the pressurizing elements 35 are driven individually. The resulting deformation of the pressurizing element 35 is transmitted to the vibration plate 40, and as the vibration plate 40 is deformed, the volume of the pressurizing chamber 36 increases or decreases. As a result, a pressure is applied to the ink in the pressurizing chamber 36, and the ink, passing through the nozzles 18, is ejected in the form of ink droplets from the ejection apertures 18a. Even when no ink droplets are being ejected, ink is present in the nozzle 18, forming a meniscus face M.

The printer 100 further includes an operation panel 27, a storage portion 28, and a communication portion 29.

The operation panel 27 is an operation portion for receiving input of various settings. For example, a user can operate the operation panel 27 to input information on the size of the sheets P to be set in the sheet feeding cassette 2, that is, the size of the sheets P to be conveyed by the first conveying belt 8. The user can also operate the operation panel 27 to input the number of sheets P to be printed or to enter an instruction to start a printing job. The operation panel 27 also functions as a notification device for giving a notification related to the operation status (image recording, or flushing described later) of the printer 100.

The storage portion 28 is a memory for storing an operation program for the control device 110 along with various kinds of information and is configured to include a ROM (read-only memory), a RAM (random-access memory), and a non-volatile memory. Information (for example, information on the size and number of sheets P) set on the operation panel 27 is stored in the storage portion 28.

The communication portion 29 is a communication interface for transmitting and receiving information to and from an external device (for example, a personal computer (PC)). For example, when a user operates a PC and transmits to the printer 100 a print command together with image data, the image data and print command are fed to the printer 100 via the communication portion 29. In the printer 100, the main control portion 110a can control the recording heads 17a to 17c based on the image data to make them eject ink and thereby record an image on a sheet P.

The printer 100 of this embodiment includes the control device 110. The control device 110 is configured to include, for example, a CPU (central processing unit) and a memory. Specifically, the control device 110 includes the main control portion 110a, a flushing control portion 110b, a sheet feeding control portion 110c, a maintenance control portion 110d, and an image processing portion 110e. Although the different control portions constituting the control device 110 are configured as one CPU, they may be configured as separate CPUs.

The main control portion 110a controls the operation of different parts in the printer 100. For example, the driving of the rollers inside the printer 100 and the ejection of ink from the recording heads 17a to 17c during image recording (except during flushing) is controlled by the main control portion 110a.

The flushing control portion 110b, based on the detection of the position of the openings 80 (opening groups 82) by the belt sensor 24 or 25, makes the recording heads 17a to 17c perform flushing. The flushing based on the detection of the position of the openings 80 will be described in detail later.

The sheet feeding control portion 110c is a recording medium feeding control portion that controls the pair of registration rollers 13 as a recording medium feeding portion. For example, the sheet feeding control portion 110c controls the pair of registration rollers 13 based on the detection of the position of the openings 80 by the belt sensor 24 or 25. The sheet feeding control portion 110c can also control the pair of registration rollers 13 independently of the detection of the position of the openings 80 by the belt sensor 24 or 25 (that is, regardless of position detection).

The maintenance control portion 110d controls the recording heads 17a to 17c to perform the purging described above in which ink is forcibly pushed out of the nozzles 18. When the maintenance control portion 110d makes the recording heads 17a to 17c perform the purging, it also controls the driving (for example, moving to and retracting from under the recording portion 9) of the maintenance unit 19 described above.

The image processing portion 110e performs image processing on image data to generate printing data in which pixel data constituting image data to be printed is represented in multiple gradations (256 gradations). Then, the image processing portion 110e, based on the printing data, generates drive waveform selection data in a predetermined number of gradations (for example, two gradations). The generated drive waveform selection data is stored in the buffer 32 in the head driver 26.

As shown in FIG. 3, the printer 100 includes, on the inner circumferential face side of the first conveying belt 8, ink receiving portions 31Y, 31M, 31C, and 31K. The ink receiving portions 31Y to 31K, when flushing is performed by the recording heads 17a to 17c, receive and collect the ink ejected from the recording heads 17a to 17c and having passed through the openings 80 in the first conveying belt 8. Thus, the ink receiving portions 31Y to 31K are provided at positions opposite the recording heads 17a to 17c in the line heads 11Y to 11K respectively across the first conveying belt 8. The ink collected in the ink receiving portions 31Y to 31K is sent via an ink discharging passage (not shown) to, for example, a waste ink tank (not shown) to be disposed of.

The second conveying unit 12 includes a second conveying belt 12a and a dryer 12b. The second conveying belt 12a is stretched around a driving roller 12c and a driven roller 12d. The sheet P conveyed by the first conveying unit 5 and having an image recorded on it by ink ejection by the recording portion 9 is, while being conveyed by the second conveying belt 12a, dried by the dryer 12b and is conveyed to the decurler portion 14 described above.

### 2. Details of the First Conveying Belt

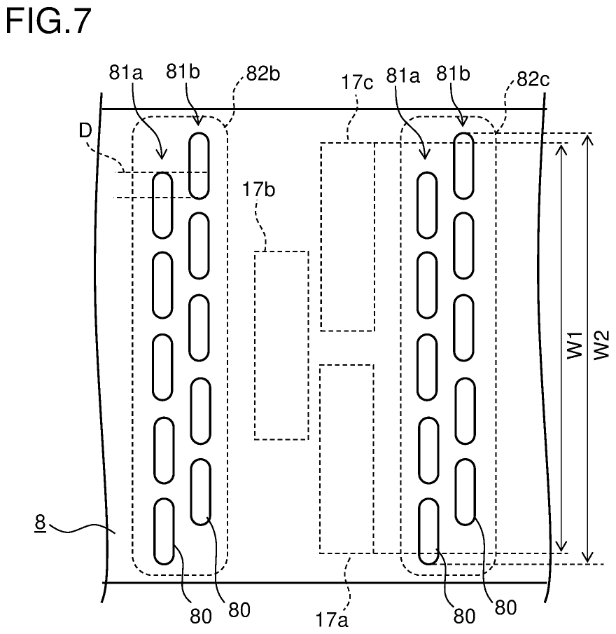

Next, the first conveying belt 8 in the first conveying unit 5 will be described in detail. FIG. 6 is a plan view showing one example of the structure of the first conveying belt 8 used in the printer 100 according to the present disclosure. FIG. 7 is a partly enlarged view of and around a second opening group 82b and a third opening group 82c in the first conveying belt 8 in FIG. 6.

In the embodiment, a negative pressure suction method is employed in which a sheet P is conveyed while being held on the first conveying belt 8 by negative pressure suction. Thus, the first conveying belt 8 has a large number of suction holes 8a formed in it over its entire area to pass the suction air with which to hold the sheet P on the first conveying belt 8 by negative pressure suction.

The first conveying belt 8 has a plurality of openings 80 to let pas through, during flushing, ink ejected from the nozzles 18 in the recording heads 17a to 17c. The openings 80 are formed as holes that are elongate in the width direction (arrow BB′ direction; hereinafter also referred to simply as the width direction) of the first conveying belt 8. In the embodiment, the openings 80 are shaped such that, as seen in a plan view, their parts corresponding to the corners of a rectangular are rounded as shown in FIG. 7. Instead, the openings 80 may have a rectangular or any other shape (for example, in an oval shape).

In the embodiment, the first to seventh opening groups 82a to 82g composed of a plurality of openings 80 arrayed in the width direction and in the conveying direction of the first conveying belt 8 (arrow A direction; hereinafter also referred to simply as the conveying direction) are arranged, in one turn S of the first conveying belt 8, at seven places at predetermined intervals along the conveying direction. The opening groups 82a to 82g each have two opening rows 81a to 81b. The opening groups 82a to 82g are formed not at equal intervals but at irregular positions in accordance with the size of the sheet P to be conveyed. That is, the intervals between every two adjacent opening groups 82 in the sheet conveying direction are not constant but are different from one another. Here, the maximum interval between two adjacent opening groups 82 in the conveying direction is larger than the length, in the conveying direction, of the smallest-sized sheet P printable (for example, A4 landscape) when it is placed on the first conveying belt 8.

In each of the opening rows 81a and 81b, a plurality of (here, five) openings 80 are arranged at equal intervals in the width direction. The openings 80 in one opening row 81a are arranged such that, as seen from the conveying direction, parts of them in the belt width direction (end parts in the longitudinal direction) overlap the openings 80 in the other opening row 81b (so that there are overlaps D). That is, in the first conveying belt 8, a plurality of openings 80 constituting each of the opening group 82 are arranged in a staggered manner. The number of openings 80 in the one opening row 81a may be different from that in the other opening row 81b.

Here, assuming that the head width of the line heads 11Y to 11K (recording heads 17a to 17c) is W1 (mm), the width W2 (mm) of the opening group 82 in the belt width direction is larger than W1. In this way, when the recording heads 17a to 17c perform flushing, ink ejected from the nozzles 18 in the recording heads 17a to 17c passes through either the openings 80 in the opening row 81a or the openings 80 in the opening row 81b. It is thus possible to make the recording heads 17a to 17c perform flushing over the whole head width and thereby reduce nozzle clogging due to ink dehydration with respect to all the nozzles 18.

In the embodiment, the control device 110 (for example, the flushing control portion 110b) determines, in one turn S of the first conveying belt 8, the pattern (combination), in the sheet conveying direction, of a plurality of opening groups 82 used in flushing in accordance with the size of the sheet P to be used. More specifically, the control device 110 makes the belt sensor 24 or 25 read the reference specifying portion Mref of the first conveying belt 8 and, based on information on the position of the reference specifying portion Mref and on the size of the sheet P, changes the timing with which to convey the sheet P from the pair of registration rollers 13 to the first conveying belt 8; this achieves control such that the first to seven opening groups 82a to 82g appear at a prescribed period between sheets P that are conveyed sequentially.

The control device 110 can recognize the size of the sheet P to be used based on information (for example, information on the size of the sheet P entered on the operation panel 27) stored in the storage portion 28. The timing with which to perform flushing is not limited to “between sheets”. For example, flushing can also be performed before an image is formed on the first sheet P in a series or after an image is formed on the last sheet P in a series.

### 3. Selection of a Drive Waveform in Flushing Operation

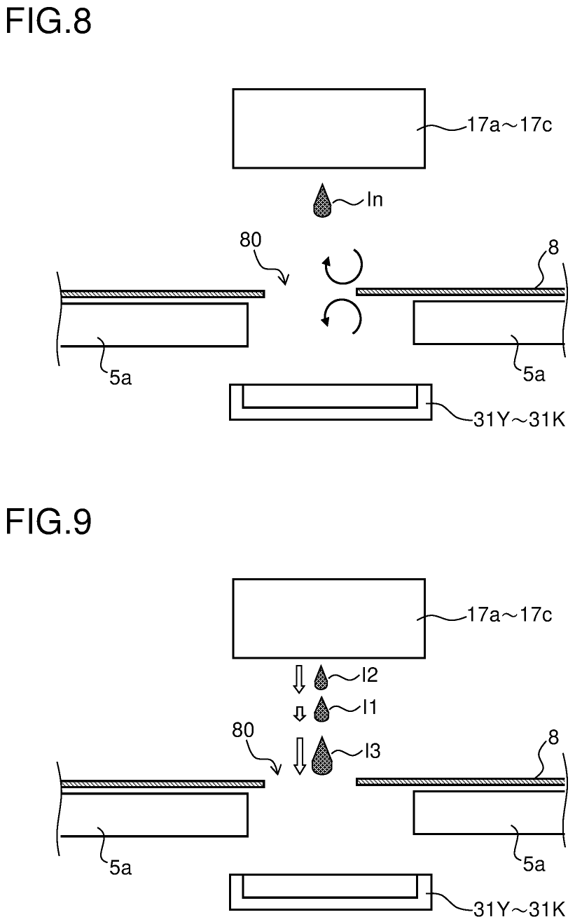

Next, a drive waveform used for flushing operation performed in the printer 100 of the embodiment will be described. FIG. 8 is a schematic diagram showing the air flows around the first conveying belt 8 when the first conveying belt 8 passes under the recording heads 17a to 17c. The air flows around the first conveying belt 8 are those observed by driving the first conveying belt 8 in a smoke-filled chamber and visually checking the movement of the smoke under the recording heads 17a to 17c.

As shown in FIG. 8, under the recording heads 17a to 17c, a belt supporting frame 5a that supports the first conveying belt 8 is not located and a space is left between the recording heads 17a to 17c and the ink receiving portions 31Y to 31K. Thus, as indicated by arrows in FIG. 8, disturbed air flows arise in such a way as to approach the first conveying belt 8 from its obverse and reverse sides and then turn around.

Under the effect of these air flows, the flying direction of the ink droplets In ejected from the nozzles 18 (see FIG. 5) in the recording heads 17a to 17c toward the openings 80 in the first conveying belt 8 may be disturbed, and this may cause the ink droplets In to land on elsewhere than the openings 80 to contaminate the first conveying belt 8 and the belt supporting frame 5a. In particular, if the ink droplets In ejected from the nozzles 18 split, the split ink droplets In have a smaller mass, and thus the ink droplets are more likely to be swept off by the air flows.

Thus, in the embodiment, in flushing operation, a drive waveform that causes no splitting in ink droplets In is used to keep the mass of the ink droplets In large so that they are less likely to be affected by air flows.

Here, “droplet splitting” denotes a phenomenon in which, in one ejection operation, an ink droplet is ejected as two or more split droplets. When an ink droplet is ejected from a nozzle 18, ink stretches in a columnar shape from the ejection aperture 18a and then becomes an ink droplet under surface tension. When the ink column is split into, for example, a head end part, a middle part, and a tail end part, head and tail end parts become fine liquid droplets with low flying speeds and the middle part becomes a comparatively large liquid droplet with a high flying speed.

Here, the liquid droplet of the head end part is caught up by that of the middle part and merges with it before passing through the opening 80, whereas the liquid droplet of the tail end part falls behind that of the middle part and passes through the openings 80 separately. Thus, to make ink droplets less likely to be affected by air flows, it is necessary to select a drive waveform with which droplet splitting is unlikely to occur in the tail end part.

Next, the drive waveform used in flushing operation will be described. During image recording, it is necessary to increase the amount of ink ejected per pixel for high pixel density. Here, if the amount of ink per one ejection operation is too large, ink cannot be supplied to the pressurizing chamber 36 (see FIG. 5) in time and this causes an insufficient supply of ink. Thus, the amount of ink to be ejected for one pixel may be ejected in two operations (in two droplets).

Here, by selecting a drive waveform with which, before the ink droplet ejected first passes through the openings 80, the subsequent ink droplet catches up and merges with the first ink droplet, it is possible to increase the mass of the ink droplet that passes through the opening 80 to make it less likely to be affected by air flows.

FIG. 9 is a schematic diagram showing how two ink droplets I1 and I2 unite (merge), while flying, into one ink droplet I3 and pass through the openings 80. In FIG. 9, hollow arrows beside the ink droplets I1 to I3 indicate the ejection speed (flying speed) of the ink droplets I1 to I3.

As shown in FIG. 9, the ink droplets I1 and I2 are successively ejected by a first pulse for ejecting the ink droplet I1 at a predetermined ejection speed and a second pulse for ejecting the ink droplet I2 at an ejection speed higher than by the first pulse, so that, while flying, the two ink droplets I1 and I2 unite (merge) into one ink droplet I3 to pass through the opening 80. In this case, the ejection speed of the merged ink droplet I3 depends on the composite speed of the ejection speeds of the two ink droplets I1 and I2.

In this way, by successively ejecting ink droplets I1 and I2 and increasing the ejection speed of the second ink droplet I2, it is possible to merge them, while flying, into an ink droplet I3 with a larger volume and an increased ejection speed. The ink droplet I3 with a larger volume and an increased ejection speed is less likely to be affected by air flows; it is thus possible to reliably make ink droplets pass through the openings 80 to land on the ink receiving portions 31Y to 31K.

### 5. Others

The embodiment described above is in no way meant to limit the present disclosure, which thus allows for many modifications and variations within the spirit of the present disclosure. For example, while the above embodiment deals with a case where the sheet P is conveyed while being held on the first conveying belt 8 by negative pressure suction, the sheet P may be conveyed while being held by electrostatic suction on the electrostatically charged first conveying belt 8 (an electrostatic suction method).

While the embodiment described above deals with an example where used as an ink-jet recording apparatus is a printer 100 that records a color image using four-color ink, the structure of the embodiment can also be used in a monochrome printer that records a monochrome image using black ink.

The present invention is applicable to ink-jet recording apparatuses such as ink-jet printers.

What is claimed is:

1. An ink-jet recording apparatus comprising:
a recording head including
a plurality of pressurizing chambers which communicate with a plurality of nozzles for ejecting ink and in which ink is storable and
a plurality of pressurizing elements which are arranged so as to correspond to the plurality of pressurizing chambers and which apply a pressure to the ink in the pressurizing chambers to eject ink from the nozzles;
a head driver which includes a driving pulse generator that applies a drive voltage to the pressurizing elements to generate a drive waveform for ejecting ink from the nozzles, the head driver making each of the nozzles eject ink for one piece of pixel data in image data to be printed in accordance with gradation of the pixel data;
a conveying belt which is endless and has a plurality of openings, the conveying belt conveying, while holding, a recording medium; and
a control portion which controls driving of the head driver and the conveying belt to perform flushing in which ink droplets are ejected from the nozzles in the recording head to pass through one of the plurality of openings with a timing different from a timing with which to record an image,
wherein
the control portion performs the flushing using the drive waveform with which the ink droplets ejected from the nozzles each become one droplet before passing through the openings.

2. The ink-jet recording apparatus according to claim 1,
wherein
the control portion performs the flushing using the drive waveform with which two ink droplets are ejected by a first pulse for ejecting an ink droplet at a predetermined ejection speed and a second pulse for ejecting an ink droplet at an ejection speed higher than by the first pulse such that, while flying, the two ink droplets unite into one ink droplet.

3. The ink-jet recording apparatus according to claim 2,
wherein
when ejecting the two ink droplets, the control portion ejects in two operations an amount of ink to be ejected for one pixel.

4. The ink-jet recording apparatus according to claim 1,
wherein
under the recording head, an ink receiving portion is provided which receives the ink droplets having passed through the openings when the flushing is performed, and
between the recording head and an obverse face of the conveying belt, and between the ink receiving portion and a reverse side of the conveying belt, air flows arise in such a way as to first approach the conveying belt from the obverse and reverse sides thereof and then turn around.
